(19) United States
(12) Patent Application Publication
(10) Pub. No.: US 2009/0274877 A1
(43) Pub. Date: Nov. 5, 2009

(54) STIMULI-RESPONSIVE SURFACES

(76) Inventors: Edwin Chan, Montgomery Village, MD (US); Jeffrey M. Karp, Chestnut Hill, MA (US); Robert S. Langer, Newton, MA (US)

Correspondence Address: CHOATE, HALL & STEWART LLP, TWO INTERNATIONAL PLACE, BOSTON, MA, 02110, US

(21) Appl. No.: 12/402,154

(22) Filed: Mar. 11, 2009

Related U.S. Application Data
(60) Provisional application No. 61/035,620, filed on Mar. 11, 2008.

(51) Int. Cl. B32B 3/30; C08F 2/46; B32B 37/14

(52) U.S. Cl. 428/167; 522/110; 156/60

(57) ABSTRACT

A material capable of promoting adhesion through transitioning reversibly between a first state and a second state when the material is exposed to or removed from a stimulus, wherein, the first state includes a first texture and the second state includes a second texture different from the first texture.

### CROSS-REFERENCE TO RELATED APPLICATION

This application claims priority to U.S. Provisional Patent Application 61/035,620, filed on Mar. 11, 2008, and entitled “Stimuli Responsive Surfaces”, hereby incorporated by reference.

### GOVERNMENT SUPPORT

The United States Government has provided grant support utilized in the development of one or more of the present inventions. In particular, Grant No. BES-0609182, awarded by the National Science Foundation (“NSF”) has supported development of one or more of the inventions of the present application. The United States Government may have certain rights in these inventions.

### BACKGROUND

Responsive materials are materials that undergo drastic property changes in response to specific external stimuli. These materials are potentially useful for applications that require the dynamic control of interfacial properties such as adhesion. In particular, a responsive material that can tailor the adhesion of a wet, compliant interface will be especially interesting in many biologically-relevant applications since they typically involve controlling interfacial properties within an aqueous environment.

Tissue adhesives have a variety of medical applications, such as wound healing sealants, adhesion barriers, and drug delivery patches. Some tissue adhesives, such as those based on cyanoacrylates, fibrin, collagen and other formulations including proteins or polyurethane pre-polymers, can have limited applications due to problems associated with histotoxicity, cytotoxicity, carcinogenicity, and risk of embolization or intravascular coagulation. Additionally, the mechanical properties of certain adhesives do not match the underlying tissue, which can limit their long-term effectiveness.

### SUMMARY

The present invention encompasses a material capable of promoting adhesion through transitioning reversibly between a first state and a second state when the material is exposed to or removed from a stimulus, wherein, the first state including a first texture and the second state including a second texture different from the first texture.

In some embodiments, the texture returns to the first state when the stimulus changes. In some embodiments, the stimulus change is removal of the stimulus, reduction in the degree of the stimulus, increase in the degree of the stimulus, addition of a second stimulus.

In some embodiments, the material is a polymer. In some embodiments, the material locally pins the interface contact from receding. In some embodiments, de-adhesion can be promoted by removing the stimulus.

In some embodiments, the first state the texture has amplitude in the range of between about 250 nm and about 500 nm and wavelength in the range of between about 250 nm and about 500 nm and during the second state the texture has amplitude in the range of between about 250 μm and about 500 μm and wavelength in the range between of about 250 μm and about 500 μm.

In some embodiments, the texture has during the first state the texture has amplitude in the range of between about 1 μm and about 50 μm and wavelength in the range of between about 25 μm and about 75 μm and during the second state the texture has amplitude in the range of between about 200 μm and about 300 μm and wavelength in the range between of about 250 μm and about 500 μm.

In various embodiments, the material includes a substrate or mold. In various embodiments, the material includes an adhesive between the material and substrate.

In various embodiments, the stimulus is hydration/dehydration, change in solvent, change in pH, change in temperature, change in pressure, exposure to electromagnetic radiation, enzymatic activity, change in ionic strength, application of an electric field, application of a magnetic field, application of mechanical stress and combinations thereof.

In some embodiments, where the stimulus is hydration, the hydration is supplied from a tissue.

In various embodiments, the polymer that is part of the material is poly(ethylene glycol methyl ether acrylate-co-acrylic acid) (“PEGA-AA”), poly(glycerol sebacate)(PGS), poly(glycerol sebacate acrylate) (PGSA), poly(lactic-co-glycolic acid) (PLGA), polycaprolactone (PCL), polyglycolide (PGA), polylactic acid (PLA), poly-3-hydroxybutyrate (PHB), polyurethane, parylene-C, keratin, carbon nanotubes, poly(anhydride), chitosan, 2-hydroxyethylmethacrylate, hylauronic acid, poly(acrylic acid), poly(ethylene glycol), copolymers and combinations thereof.

In various embodiments, the polymer is a bilayer of bulk material layer and a top layer. In some embodiments, the top layer has a thickness in the range of between about 100 nm and about 5 mm. In some embodiments, the top layer is formed from the monomers of the bulk material during initial polymerization. In some embodiments, the polymer is cross-linked.

In some embodiments, the material includes a biomolecule or pharmaceutical compound. In some embodiments, the biomolecule or pharmaceutical compound is anti-AIDS substances, anti-cancer substances, antibiotics, immunosuppressants, anti-viral substances, enzyme inhibitors, neurotoxins, opioids, hypnotics, anti-histamines, lubricants, tranquilizers, anti-convulsants, muscle relaxants and anti-Parkinson substances, anti-spasmodics and muscle contractants including channel blockers, miotics and anti-cholinergics, anti-glaucoma compounds, anti-parasite and/or anti-protozoal compounds, modulators of cell-extracellular matrix interactions including cell growth inhibitors and pro- or anti-adhesion molecules, vasodilating agents, inhibitors of DNA, RNA or protein synthesis, anti-hypertensives, analgesics, anti-pyretics, steroidal and non-steroidal anti-inflammatory agents, pro- or anti-angiogenic factors, pro- or anti-secretory factors, anticoagulants and/or antithrombotic agents, local anesthetics, ophthalmics, prostaglandins, anti-depressants, anti-psychotic substances, anti-emetics, growth factors, proton pump inhibitors, hormones, vitamins, gene delivery systems, RNAi, vitamins and imaging agents.

In some embodiments, the material includes a plurality of cells. In some embodiments, the cells are kerotinocytes, fibroblasts, ligament cells, endothelial cells, epithelial cells, muscle cells, nerve cells, kidney cells, lung cells, hepatocytes, neuroblastoma, skin cells, islet cells, urothelial cells, bladder cells, intestinal cells, chondrocytes, bone-forming cells, and/or stem cells, such as human embryonic or adult stem cells or mesenchymal stem cells, reprogrammed cells, hematapoetic cells, cardiac cells, cells from Wharton's jelly and perivascular cells.

In various embodiments, the texture has a pattern. In various embodiments, the texture is in a random arrangement.

In various embodiments, the transition from the first state to the second state results in a change in the range between about 50%, and about 500%.

In various embodiments, the material is in the form of a tape.

In various embodiments, the material has greater adhesion against deformable surfaces than against rigid surfaces.

In various embodiments, the material is contacted to a superstrate. In various embodiments, the material is adhered to a wet, deformable superstrate. In various embodiments, the material is adhered to a dry, deformable superstrate. In various embodiments, the superstrate prevents complete reversal of the transition from the first state to the second state.

In various embodiments, the material increases the contact line at separation of the material and superstrate due to the transition from one state to the other. In various embodiments, the contact line is increased by locally pinning the separation pathway due to the transition from one state to the other.

In various embodiments, the material and superstrate can be de-adhered through transitioning from one state to the other. In various embodiments, the transition decreases the contact line at separation.

In various embodiments, the adhesive strength is increased as the amplitude of the texture increases. In various embodiments, the increase in adhesive strength is coincident with increase in contact time with a superstrate. In various embodiments, the contact time is between 1 minute and 48 hrs.

In various embodiments, the maximum adhesive strength is obtained within the first ten minutes of contact time. In various embodiments, the material includes additives. In various embodiments, the additives are nanostructures, nanoparticles, nanocomposites, microparticles, metals, oxides, ceramics, and ions.

In various aspects, the present invention encompasses a method including contacting a material with a superstrate, where the material includes a material capable of promoting adhesion through transitioning reversibly between a first state and a second state when the material is exposed to or removed from a stimulus, and the first state includes a first texture and the second state includes a second texture different from the first texture.

In various embodiments, when the stimulus changes the texture returns to the first state. In various embodiments, the change in stimulus is removal of the stimulus, reduction in the degree of the stimulus, increase in the degree of the stimulus, addition of a second stimulus.

In various embodiments, the material locally pins the contact interface contact between the material and the superstrate. In various embodiments, de-adhesion can be promoted by transitioning from one state to the other. In various embodiments, the material includes a polymer.

In various embodiments, adhesive strength is controlled by adjusting the stimulus or degree of stimulus. In various embodiments, during the first state the texture has amplitude in the range of between about 250 nm and about 500 nm and wavelength in the range of between about 250 nm and about 500 nm and during the second state the texture has amplitude in the range of between about 250 μm and about 500 μm and wavelength in the range between of about 250 μm and about 500 μm.

In some embodiments, during the first state the texture has amplitude in the range of between about 1 μm and about 50 μm and wavelength in the range of between about 25 μm and about 75 μm and during the second state the texture has amplitude in the range of between about 200 μm and about 300 μm and wavelength in the range between of about 250 μm and about 500 μm.

In various embodiments, the material includes a substrate or mold. In various embodiments, the material includes an adhesive between the material and substrate.

In various embodiments, the stimulus is hydration/dehydration, change in solvent, change in pH, change in temperature, change in pressure, exposure to electromagnetic radiation, enzymatic activity, change in ionic strength, application of an electric field, application of a magnetic field, application of mechanical stress and combinations thereof.

In various embodiments, when the stimulus is hydration, the hydration is supplied by a tissue.

In various embodiments, the polymer is of poly(ethylene glycol methyl ether acrylate-co-acrylic acid) (“PEGA-AA”), poly(glycerol sebacate)(PGS), poly(glycerol sebacate acrylate) (PGSA), poly(lactic-co-glycolic acid) (PLGA), polycaprolactone (PCL), polyglycolide (PGA), polylactic acid (PLA), poly-3-hydroxybutyrate (PHB), polyurethane, parylene-C, keratin, carbon nanotubes, poly(anhydride), chitosan, 2-hydroxyethylmethacrylate, copolymers and combinations thereof. In various embodiments, the polymer is cross-linked.

In various embodiments, the material includes a biomolecule or pharmaceutical compound. In various embodiments, the biomolecule or pharmaceutical compound anti-AIDS substances, anti-cancer substances, antibiotics, immunosuppressants, anti-viral substances, enzyme inhibitors, neurotoxins, opioids, hypnotics, anti-histamines, lubricants, tranquilizers, anti-convulsants, muscle relaxants and anti-Parkinson substances, anti-spasmodics and muscle contractants including channel blockers, miotics and anti-cholinergics, anti-glaucoma compounds, anti-parasite and/or anti-protozoal compounds, modulators of cell-extracellular matrix interactions including cell growth inhibitors and pro- or anti-adhesion molecules, vasodilating agents, inhibitors of DNA, RNA or protein synthesis, anti-hypertensives, analgesics, anti-pyretics, steroidal and non-steroidal anti-inflammatory agents, pro- or anti-angiogenic factors, pro- or anti-secretory factors, anticoagulants and/or antithrombotic agents, local anesthetics, ophthalmics, prostaglandins, anti-depressants, anti-psychotic substances, anti-emetics, growth factors, proton pump inhibitors, hormones, vitamins, gene delivery systems, RNAi, vitamins and imaging agents.

In various embodiments, the material includes a plurality of cells. In various embodiments, the cells are kerotinocytes, fibroblasts, ligament cells, endothelial cells, epithelial cells, muscle cells, nerve cells, kidney cells, lung cells, hepatocytes, neuroblastoma, skin cells, islet cells, urothelial cells, bladder cells, intestinal cells, chondrocytes, bone-forming cells, and/or stem cells, such as human embryonic or adult stem cells or mesenchymal stem cells, reprogrammed cells, hematapoetic cells, cardiac cells, cells from Wharton's jelly and perivascular cells.

In various embodiments, the texture is in a random arrangement. In various embodiments, the transition from the first state to the second state results in a change in the range between about 50%, and about 500%.

In various embodiments, the material is in the form of a tape. In various embodiments, the increase in adhesive strength is coincident with increase in contact time with a superstrate.

In various embodiments, the contact time is between 1 minute and 48 hrs. In various embodiments, the maximum adhesive strength is obtained during the first 10 minutes of contact time.

In various embodiments, the material includes additives. In various embodiments, the additives are nanostructures, nanoparticles, nanocomposites, microparticles, metals, oxides, ceramics, and ions.

In various aspects, present invention encompasses a method of making a composition including photo polymerizing a mixture of polymers and a photoinitiator in a mold or a rigid substrate.

In various embodiments, the polymer mixture includes polymers selected from the group consisting of poly(ethylene glycol methyl ether acrylate-co-acrylic acid) (“PEGA-AA”), poly(glycerol sebacate)(PGS), poly(glycerol sebacate acrylate) (PGSA), poly(lactic-co-glycolic acid) (PLGA), polycaprolactone (PCL), polyglycolide (PGA), polylactic acid (PLA), poly-3-hydroxybutyrate (PHB), hylauronic acid, poly(acrylic acid), poly(ethylene glycol), polyurethane, parylene-C, keratin, carbon nanotubes, poly(anhydride), chitosan, 2-hydroxyethylmethacrylate, copolymers and combinations thereof.

In various embodiments, the polymers mixture is polyethylene glycolmethyl ether, acrylic acid and polyethylene glycol.

In various aspects, the present invention includes a method of improving adhesion including, contacting a stimuli response material with a superstrate, applying a stimulus wherein the stimulus causes the stimuli responsive material to transition from a first state to a second state wherein the second state has a more irregular topology relative to the first state.

### DEFINITIONS

As used herein, the article “a” is used in its indefinite sense to mean “one or more” or “at least one.” That is, reference to any element of the present teachings by the indefinite article “a” does not exclude the possibility that more than one of the element is present.

The terms “adhesive strength” “adhesive strength of a bond” or “bond strength” as used herein, these terms refer to the force or work required to separate or de-adhere two materials that have an adhesive interface.

The term “amide” or “aminocarboxy” includes compounds or groups that contain a nitrogen atom that is bound to the carbon of a carbonyl or a thiocarbonyl group. The term includes “Alkylaminocarboxy” groups that include alkyl, alkenyl, or alkynyl groups bound to an amino group bound to a carboxy group. It includes arylaminocarboxy groups that include aryl or heteroaryl groups bound to an amino group which is bound to the carbon of a carbonyl or thiocarbonyl group. The terms “alkylaminocarboxy,” “alkenylaminocarboxy,” “alkynylaminocarboxy,” and “arylaminocarboxy” include groups wherein alkyl, alkenyl, alkynyl and aryl groups, respectively, are bound to a nitrogen atom which is in turn bound to the carbon of a carbonyl group.

The term “amine” or “amino” includes compounds where a nitrogen atom is covalently bonded to at least one carbon or heteroatom. The term “alkyl amino” includes groups and compounds wherein the nitrogen is bound to at least one additional alkyl group. The term “dialkyl amino” includes groups wherein the nitrogen atom is bound to at least two additional alkyl groups. The term “arylamino” and “diarylamino” include groups wherein the nitrogen is bound to at least one or two aryl groups, respectively. The term “alkylarylamino,” “alkylaminoaryl” or “arylaminoalkyl” refers to an amino group that is bound to at least one alkyl group and at least one aryl group. The term “alkaminoalkyl” refers to an alkyl, alkenyl, or alkynyl group bound to a nitrogen atom that is also bound to an alkyl group.

As used herein, “biocompatible” refers to the ability of a structure or a material to perform its desired function with respect to a medical therapy, without eliciting any undesirable local or systemic effects in the recipient or beneficiary of that therapy, but generating the most appropriate beneficial cellular or tissue response in that specific situation, and optimizing the clinically relevant performance of that therapy. (See Williams, Biomaterials 29 (2008) 2941-2953). In some embodiments, “biocompatible” means not toxic to cells. In some embodiments, a substance is considered to be “biocompatible” if its addition to cells in vivo does not induce inflammation and/or other adverse effects in vivo. In some embodiments, a substance is considered to be “biocompatible” if its addition to cells in vitro or in vivo results in less than or equal to about 50%, about 45%, about 40%, about 35%, about 30%, about 25%, about 20%, about 15%, about 10%, about 5%, or less than about 5% cell death.

As used herein, the term “biodegradable” refers to substances that are degraded under physiological conditions. In some embodiments, a biodegradable substance is a substance that is broken down (e.g., when introduced into cells, in vivo) by the cellular machinery and/or by chemical processes (e.g., hydrolysis, enzyme mediated degradation, and/or oxidative mediated degradation) into components that can either be re-used and/or disposed of without significant toxic effect (e.g., on cells (e.g., fewer than about 20% of the cells are killed when the components are added to cells in vitro)). The components typically do not induce inflammation or other adverse effects in vivo. The components can be molecular species and/or fragments of the substance. In some embodiments, the chemical reactions relied upon to break down the biodegradable compounds are uncatalyzed. As examples, “biodegradable” polymers are polymers that degrade to other species (e.g., monomeric and/or oligomeric species) under physiological or endosomal or lysosomal conditions. The polymers and polymer biodegradation products can be biocompatible. Biodegradable polymers are not necessarily hydrolytically degradable and may require enzymatic action to fully degrade. Biodegradation mechanisms can include, for example, hydrolytic degradation, enzymatic degradation, and mechanisms in which the environment naturally introduces degradation factors, and/or where a catalyst is introduced to trigger degradation.

As used herein, the term “biological tissue” refers to a collection of similar cells combined to perform a specific function, and can include any extracellular matrix surrounding the cells.

The term “biomolecules”, as used herein, refers to molecules (e.g. proteins, amino acids, peptides, polynucleotides, nucleotides, carbohydrates, sugars, lipids, nucleoproteins, glycoproteins, lipoproteins, steroids, etc.) whether naturally-occurring or artificially created (e.g., by synthetic or recombinant methods) that are commonly found in cells and tissues. Specific classes of biomolecules include, but are not limited to, enzymes, receptors, neurotransmitters, hormones, cytokines, cell response modifiers such as growth factors and chemotactic factors, antibodies, vaccines, haptens, toxins, interferons, ribozymes, anti-sense agents, plasmids, DNA, RNA, proteins, peptides, polysaccharides and any combinations of these components.

The term “carbonyl” or “carboxy” includes compounds and groups which contain a carbon connected with a double bond to an oxygen atom, and tautomeric forms thereof. Examples of groups that contain a carbonyl include aldehydes, ketones, carboxylic acids, amides, esters, anhydrides, etc. The term “carboxy group” or “carbonyl group” refers to groups such as “alkylcarbonyl” groups wherein an alkyl group is covalently bound to a carbonyl group, “alkenylcarbonyl” groups wherein an alkenyl group is covalently bound to a carbonyl group, “alkynylcarbonyl” groups wherein an alkynyl group is covalently bound to a carbonyl group, “arylcarbonyl” groups wherein an aryl group is covalently attached to the carbonyl group. Furthermore, the term also refers to groups wherein one or more heteroatoms are covalently bonded to the carbonyl group. For example, the term includes groups such as, for example, aminocarbonyl groups, (wherein a nitrogen atom is bound to the carbon of the carbonyl group, e.g., an amide), aminocarbonyloxy groups, wherein an oxygen and a nitrogen atom are both bond to the carbon of the carbonyl group (e.g., also referred to as a “carbamate”). Furthermore, aminocarbonylamino groups (e.g., ureas) are also included as well as other combinations of carbonyl groups bound to heteroatoms (e.g., nitrogen, oxygen, sulfur, etc. as well as carbon atoms). Furthermore, the heteroatom can be further substituted with one or more alkyl, alkenyl, alkynyl, aryl, aralkyl, acyl, etc. groups.

The term “contact line” as used herein, refers to the perimeter of the interface, or contact area, between two materials. For example the line at the perimeter of the interface between the stimuli-responsive surface 20 and the superstrate, which due to the topology of the stimuli-responsive surface 20 the line will not be in a single plane. During adhesion or separation the contact line changes as the two materials are contacted or withdrawn and the surface area increases or decreases. The contact line is a key geometric length-scale in defining the maximum force required for separation (Pₛ).

The term “interfacial area” as used herein refers to the true surface area of the surface, e.g., it does include the increased contact surface area resulting from the protrusions.

As used herein, the term “pharmaceutical compounds” includes “bioactive agents” and specific approved drugs. As used herein, “bioactive agents” is used to refer to compounds or entities that alter, inhibit, activate, or otherwise affect biological or chemical events. For example, bioactive agents may include, but are not limited to, anti-AIDS substances, anti-cancer substances, antibiotics, immunosuppressants, anti-viral substances, enzyme inhibitors, neurotoxins, opioids, hypnotics, anti-histamines, lubricants, tranquilizers, anti-convulsants, muscle relaxants and anti-Parkinson substances, anti-spasmodics and muscle contractants including channel blockers, miotics and anti-cholinergics, anti-glaucoma compounds, anti-parasite and/or anti-protozoal compounds, modulators of cell-extracellular matrix interactions including cell growth inhibitors and anti-adhesion molecules, vasodilating agents, inhibitors of DNA, RNA or protein synthesis, anti-hypertensives, analgesics, anti-pyretics, steroidal and non-steroidal anti-inflammatory agents, anti- or pro-angiogenic factors, anti- or pro-secretory factors, anticoagulants and/or antithrombotic agents, local anesthetics, ophthalmics, prostaglandins, anti-depressants, anti-psychotic substances, anti-emetics, and imaging agents. In certain embodiments, the bioactive agent is a drug.

A more complete listing of examples of pharmaceutical compounds (e.g., bioactive agents and specific drugs) suitable for use in various embodiments of the present inventions may be found in “Pharmaceutical Substances: Syntheses, Patents, Applications” by Axel Kleemann and Jurgen Engel, Thieme Medical Publishing, 1999; the “Merck Index: An Encyclopedia of Chemicals, Drugs, and Biologicals”, Edited by Susan Budavari et al., CRC Press, 14^{th} ed. (November 2006), and the United States Pharmacopeia-25/National Formulary-20, published by the United States Pharmcopeial Convention, Inc., Rockville Md., 2001, the entire contents of which are herein incorporated by reference.

The phrase “physiological conditions”, as used herein, relates to the range of chemical (e.g., pH, ionic strength) and biochemical (e.g., enzyme concentrations) conditions likely to be encountered in the intracellular and extracellular fluids of tissues. For most tissues, the physiological pH ranges from about 7.0 to 7.4.

The term “pinning” as used herein, refers to the phenomenon of a textured surface creating a substantially comparable, but inverse, texture when it is contacted with a compliant or deformable material. In the field of adhesion, pinning delays or retards the separation crack between two materials at their interface. This creates a more tortuous route for the contact line during separation, thus increasing the adhesive strength. Pinning gives rise to the self-interlocking nature of the stimuli-responsive surface described herein.

The terms “polynucleotide”, “nucleic acid”, or “oligonucleotide” refer to a polymer of nucleotides. The terms “polynucleotide”, “nucleic acid”, and “oligonucleotide”, may be used interchangeably. Typically, a polynucleotide comprises at least three nucleotides. DNAs and RNAs are polynucleotides. The polymer may include natural nucleosides (i.e., adenosine, thymidine, guanosine, cytidine, uridine, deoxyadenosine, deoxythymidine, deoxyguanosine, and deoxycytidine), nucleoside analogs (e.g. 2-aminoadenosine, 2-thiothymidine, inosine, pyrrolo-pyrimidine, 3-methyl adenosine, C5-propynylcytidine, C5-propynyluridine, C5-bromouridine, C5-fluorouridine, C5-iodouridine, C5-methylcytidine, 7-deazaadenosine, 7-deazaguanosine, 8-oxoadenosine, 8-oxoguanosine, O(6)-methylguanine, and 2-thiocytidine), chemically modified bases, biologically modified bases (e.g., methylated bases), intercalated bases, modified sugars (e.g. 2′-fluororibose, ribose, 2-deoxyribose, arabinose, and hexose), or modified phosphate groups (e.g. phosphorothioates and 5′-N-phosphoramidite linkages).

As used herein, a “polypeptide”, “peptide”, or “protein” comprises a string of at least three amino acids linked together by peptide bonds. The terms “polypeptide”, “peptide”, and “protein”, may be used interchangeably. Peptide may refer to an individual peptide or a collection of peptides. Inventive peptides preferably contain only natural amino acids, although non-natural amino acids (i.e., compounds that do not occur in nature but that can be incorporated into a polypeptide chain; see, for example, http://tirrell-lab.caltech.edu/Research, which displays structures of non-natural amino acids that have been successfully incorporated into functional ion channels) and/or amino acid analogs as are known in the art may alternatively be employed. Also, one or more of the amino acids in an inventive peptide may be modified, for example, by the addition of a chemical entity such as a carbohydrate group, a phosphate group, a farnesyl group, an isofarnesyl group, a fatty acid group, a linker for conjugation, functionalization, or other modification, etc. In some embodiments, the modifications of the peptide lead to a more stable peptide (e.g., greater half-life in vivo). These modifications may include cyclization of the peptide, the incorporation of D-amino acids, etc.

The term “projected area” as used herein refers to the overall macroscopic area of a surface and does not account for increased surface area due to surface roughness (e.g., due to protrusions).

The term “rigid” as used herein generally means mechanically stiff enough to prevent the stimuli-responsive surface from curving due to internal tension.

### BRIEF DESCRIPTION OF DRAWINGS

FIGS. 1A, 1B and IC are representations of a transition from a first state to a second state and returning to the first state by a stimuli response surface.

FIGS. 2A, 2B, 2C and 2D are representations of the transition from the first state to the second state and returning to the first state with application of a specific stimulus.

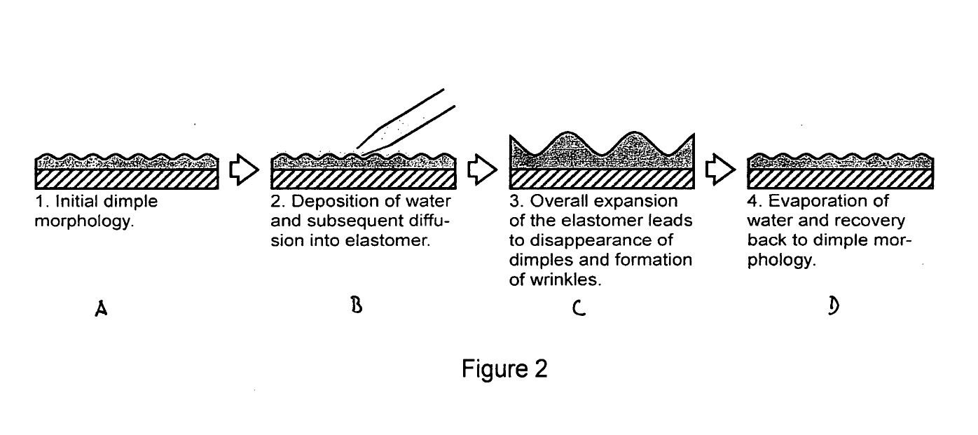

FIG. 3 depicts a method of making the stimuli-responsive surface and the mechanism of wrinkling.

FIGS. 4A and 4B are time lapse photomicrographs of the stimuli-responsive surface undergoing application of a stimulus, subsequent transition from a first state to a second state and returning to the first state.

FIG. 5 depicts the relationship between film thickness and the amplitude of the texture of the stimuli-responsive surface for different weight percentages of photoinitiator present in the polymerization mixture. Filled circles correspond to 1% by weight; filled squares correspond to 2% by weight; filled triangles correspond to 3% by weight; filled diamonds correspond to 4% by weight.

FIG. 6 depicts the relationship between film thickness and the wavelength of the texture of the stimuli-responsive surface for different weight percentages of photoinitiator present in the polymerization mixture. Filled circles correspond to 1% by weight; filled squares correspond to 2% by weight; filled triangles correspond to 3% by weight; filled diamonds correspond to 4% by weight.

FIG. 7 depicts the relationship between percentage of photoinitiator present in the polymerization mixture, thickness of the film layer and residual stress in the total film based on radius of curvature after removal of substrate.

FIG. 8 depicts the relationship between percentage of photoinitiator present in the polymerization mixture, thickness of the film layer and residual stress in the total film based on radius of curvature after removal of substrate, on a logarithmic scale based on the formula

1/R₁=(6σhₛ/Eₛ)*(1/hₛ2)

FIG. 9 depicts the surface texture wavelength during the transition from the first state at time 0 to the second state at about time 30 to time=60, and the return to the first state for four different weight percentages of photoinitiator. Peaks of the graph lines correspond to λ_{w} and values at time zero correspond to λ_{d}.

FIG. 10 depicts the overall change in wavelength of the surface texture based on change in time.

FIG. 11 depicts photomicrographs of a transition from a first state to a second state and returning to the first state by a stimuli response surface.

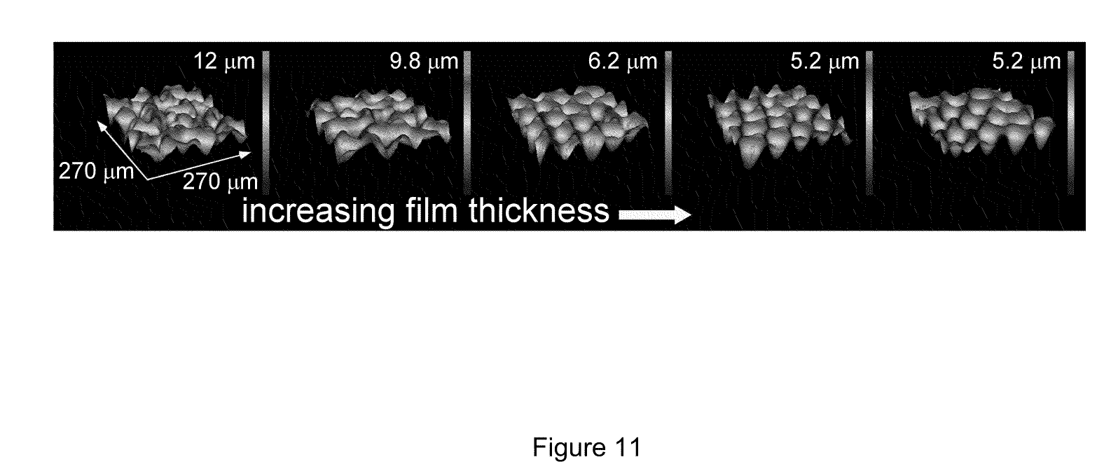

FIG. 12 depicts formation of surface wrinkles and the dynamic evolution of morphology as a function of swelling time in water. b, Increase in wavelength (λ) as a function of swelling time. c,d, Schematic representation of the wrinkling process illustrating (c) the increase in wrinkle wavelength and amplitude with swelling time and (d) the mechanism of wrinkle formation. FIG. 12D shows water diffusion into the elastomer and resultant swelling. The upper region of the elastomer tends to expand resulting in tension, what the bottom region resists expansion due to confinement of the rigid substrate resulting in compression. The net compressive stress develops as a result of the two competing forces, which leads to the formation of surface texture.

FIG. 13 depicts Schematic representation of the adhesion test procedure for the p(PEGA-AA) hemispherical probe in contact with the wet gelatin surface. b, The optical micrographs describe the interfacial contact history of a representative adhesion test illustrating the formation of a wrinkled interface and the separation process. The area within the enclosed red circle represents the region in contact. The plot is the force-time history of the same adhesion test. We use the maximum tensile force at separation (Ps) as a descriptor of adhesion. The compressive force does not change during the contact time, which indicates that the swelling process does not increase the overall dimensions of the adhesive probe significantly.

FIG. 14 depicts Changes in adhesion of the p(PEGA-AA) with contact time to the gelatin surface. a, Ps versus contact time and the normalized separation force (Ps,n) versus contact time for the p(PEGA-AA)-gelatin system. Ps,n is the ratio of Ps at contact time=t versus Ps at contact time=0 s. b, Changes in wrinkle wavelength (λs) versus contact time. λs is defined as the wavelength observed at the point of maximum separation. Due to this wavelength change, it is expected that the true contact area, which is a function of the wavelength and amplitude of the wrinkles, would change as well. However, theoretical prediction of the relative change in contact area with time shows little correlation (inset figure).

FIG. 15 Enhancement of adhesion by the proposed “self-interlocking” mechanism. a, The relative enhancement in Ps for the p(PEGA-AA)-gelatin system is attributed to lengthening of the contact line by the height, or amplitude of the wrinkles. The optical micrographs illustrate change in contact perimeter (highlighted by red circles) between the two systems at the point of Ps and 15 sec. after this point. The “self-interlocking” mechanism is available for the p(PEGA-AA)-gelatin system since the wrinkled interface locally pins the contact from receding. b, Normalized contact line (Ls,n) versus contact time for the p(PEGA-AA)-gelatin system at the point of maximum separation. Ls,n is the ratio of Ls at contact time=t versus Ls at contact time=0.

FIG. 16 depicts the difference in contact line between low and high amplitude surface textures as two surfaces are surfaces are withdrawn from a superstrate.

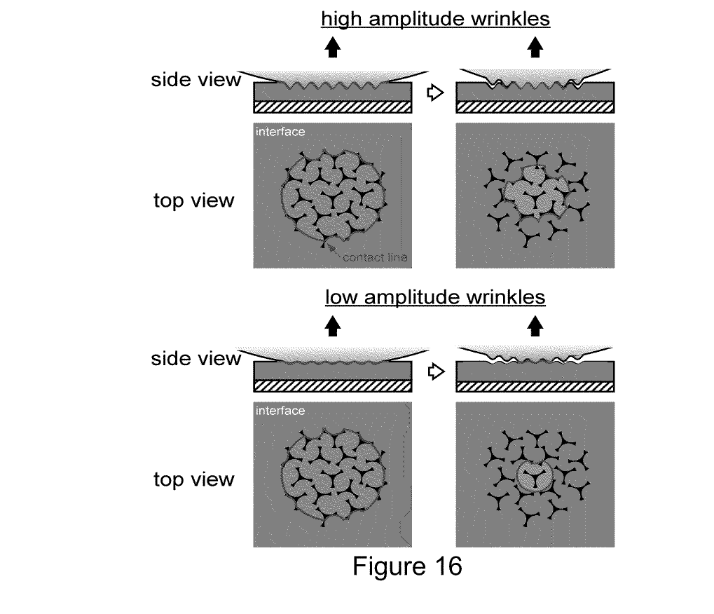

### DETAILED DESCRIPTION OF EMBODIMENTS

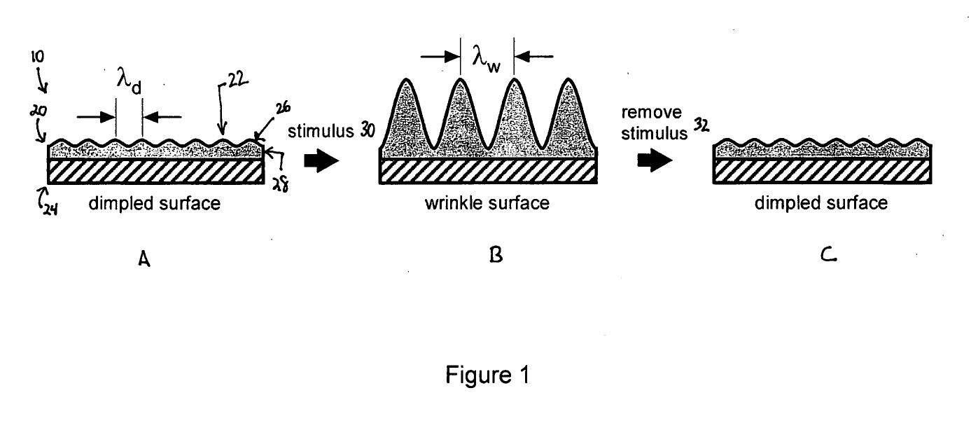

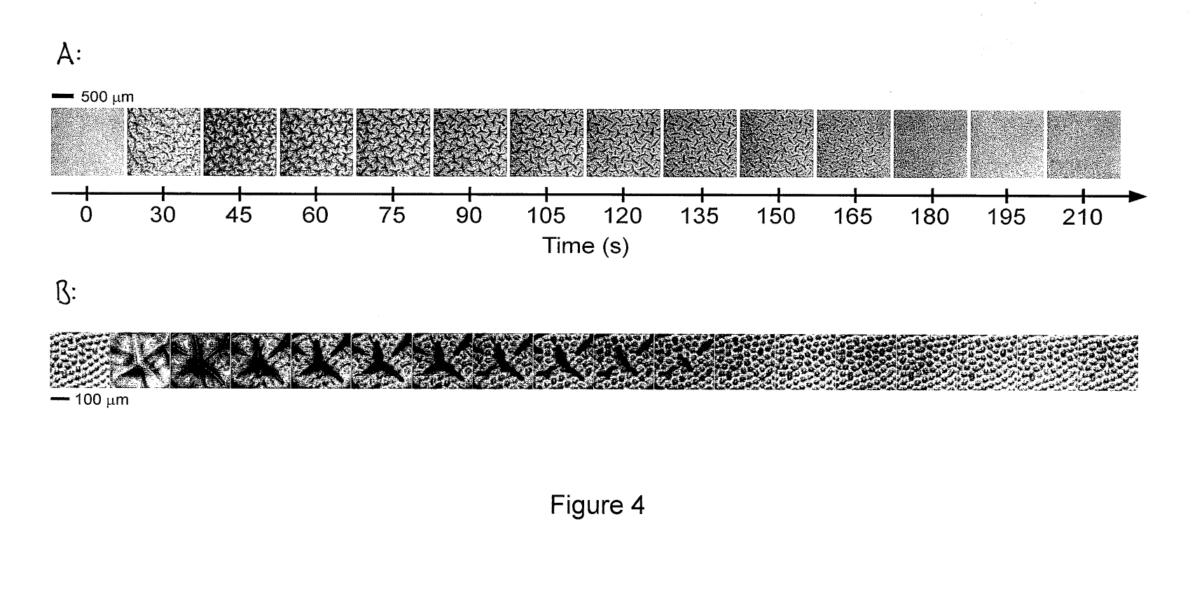

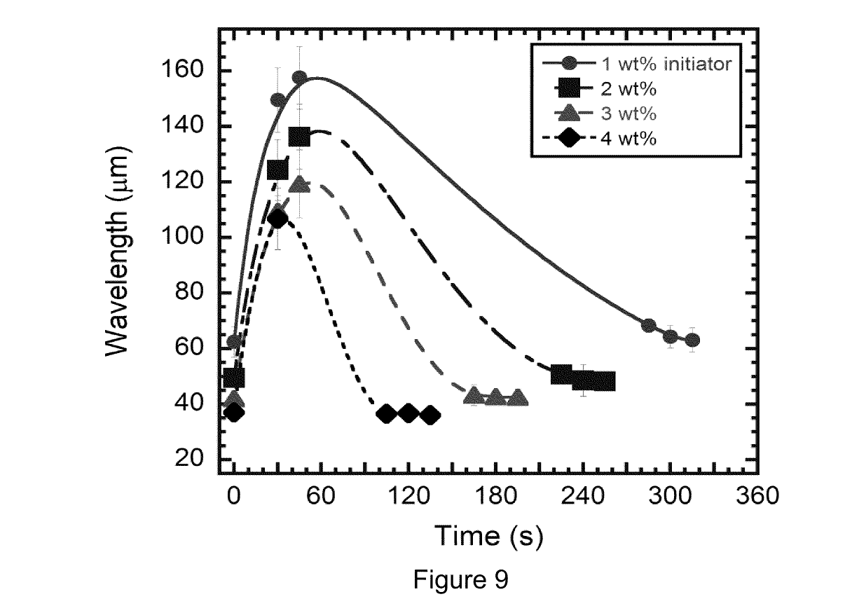

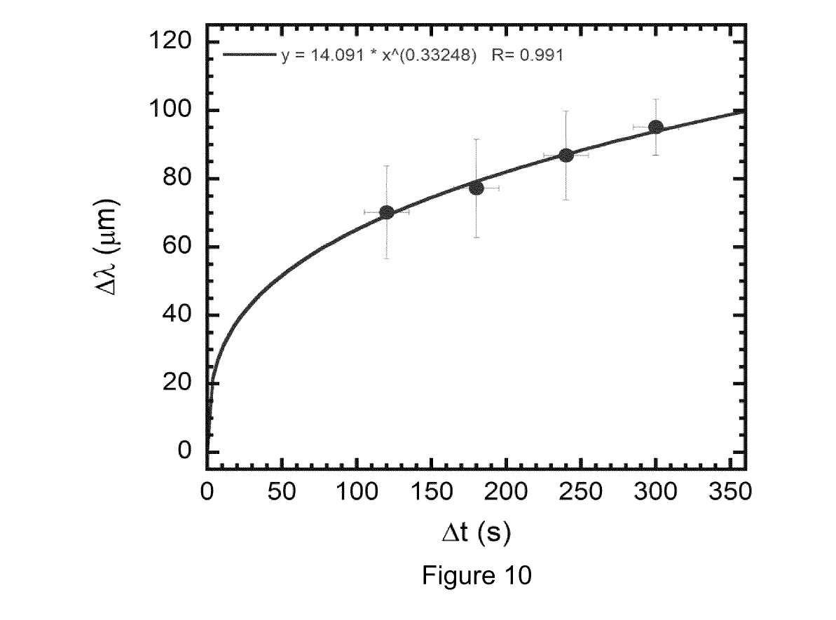

FIG. 1 shows an exemplary adhesive device 10. As shown, the device 10 includes a stimuli-responsive surface 20 for improved adhesion, and a substrate 24. The stimuli-responsive surface 20 includes a top surface 26, bulk layer 28, and surface texture features 22 (e.g., wrinkles). FIG. 1 illustrates a transition from a first state (e.g., FIG. 1A) to a second state (e.g., FIG. 1B) as a result of the application of a stimulus 30 (see, e.g., FIGS. 4, 9 and 10). Further, FIG. 1 shows a reverse transition upon removal of the stimulus 32 returning to the first state. In some embodiments, the stimuli-responsive surface 20 contacts a superstrate (not shown in FIG. 1). In various embodiments, the superstrate is a material with which the stimuli-responsive surface 20 interfaces, or is contacted with. The interface with the superstrate is generally with the top surface 26 of stimuli-responsive surface 20. In various embodiments, the superstrate can be any material (e.g., biological tissue). In various embodiments, the superstrate provides the stimulus 30 resulting in the transition of the stimuli-responsive surface 20 from the first state to the second state (see, e.g., FIGS. 4 and 9). In various embodiments, the stimuli-responsive surface does not include substrate 24.

The transition between two states shown in FIGS. 1A and 1B is an increase in the amplitude and the wavelength (λ) of the surface texture features 22. Despite the use of the terms amplitude and wavelength, the surface texture need not be ordered, repetitive or consistent. In various embodiments, the surface texture is a random arrangement of wrinkles and creases in an irregular, rumpled topology (e.g., FIGS. 4A and 4B, in particular the first two micrographs of each).

The stimuli-responsive surface 20 include (e.g., be made entirely from) a polymer. Exemplary polymers include, but are not limited to poly(ethylene glycol methyl ether acrylate-co-acrylic acid) (“PEGA-AA”), poly(glycerol sebacate)(PGS), poly(glycerol sebacate acrylate) (PGSA), poly(lactic-co-glycolic acid) (PLGA), polycaprolactone (PCL), polyglycolide (PGA), polylactic acid (PLA), and/or poly-3-hydroxybutyrate (PHB), polyurethane, parylene-C, keratin, carbon nanotubes, poly(anhydride), and chitosan and 2-hydroxyethylmethacrylate, hylauronic acid, poly(acrylic acid), poly(ethylene glycol), poly(propylene fumarate), poly(acrylamide), poly(n-isopropyl acrylamide), various biodegradable materials known in the art co-polymers and combinations thereof. In various embodiments, the stimuli-responsive surface 20 is comprised of a superporous hydrogel, as described in U.S. Patent Application Publication Number 2008/0089940, the contents of which are herein incorporated by reference. The superporous hydrogel comprises an ethylenically-unsaturated monomer is mixed with one or more of the following components: one or more co-monomers comprising ion-complexable sites one or more crosslinkers, diluents, surfactants, foaming agents, foaming aids, and initiators, to form a polymerization reaction.

The ethylenically-unsaturated comonomer used to make the superporous hydrogel of the invention can be acrylic acid (AA) and salts thereof, C₁₋₆ alkyl esters of acrylic acid and salts thereof, methacrylic acid and salts thereof, C₁₋₆ alkyl esters of methacrylic acid, acrylamide (AM), C₁₋₆ methacrylic acid and salts thereof, C₁₋₆ alkyl esters of methacrylic acid, acrylamide (AAm), C₁₋₆ alkylamides of acrylic acid, C₂₋₁₂ dialkylamides of acrylic acid, N-isopropylacrylamide (NIPAM), methacrylamide, C₁₋₆ alkylamides of methacrylic acid, C₂₋₁₂ dialkylamides of methacrylic acid, N-cyclopropyl methacrylamide, N,N-dimethylaminoethyl acrylate, acrylonitrile, 2-hydroxyethyl acrylate (HEA), ethyl acrylate, butyl acrylate, isodecyl methacrylate, methyl methacrylate, lauryl methacrylate, stearyl methacrylate, 2-hydroxypropyl acrylate, 2-hydroxypropyl methacrylate (HPMA), butanediol monoacrylate, itaconic acid, N-vinyl pyrrolidone (VP), N,N-dimethylaminoethlyl acrylate, dialkyldimethylammonium chloride (DADMAC), 2-(methacryloyloxy)ethyl trimethylammonium chloride, 2-acrylamido-2-methyl-1-propanesulfonic acid (AMPS), potassium 3-sulfopropyl acrylate (SPAK), potassium 3 sulfopropyl methacrylate (SPMAK), or 2-(acryloyloxyethyl)trimethylammonium methyl sulfate (ATMS). Preferably, the comonomer is AAm, NIPAM, HEA, AAc or salts thereof, methacrylic acid or salts thereof, DADMAC, or SPMAK. More preferably, the mixture includes a combination of acrylic acid and HEA comonomers.

Desirably, the concentration of comonomer is from about 0.5% to about 20% (v/v), preferably about 5% to about 15% (v/v), and most preferably about 10% (v/v), of the total reaction mixture when present. Most desirably, the reaction mixture includes 2-hydroxymethyl methacrylate (HEMA) as a primary monomer and a comonomer selected from one or more of AAm, NIPAM, Methacrylic Acid, AAC, or salts thereof, DADMAC, or SPMAK.

Crosslinking agents can be N,N′-methylenebisacrylamide (BIS), N,N′-ethylenebisacrylamide (EBA), polyethylene glycol diacrylate (PEGDA), polyethylene glycol dimethacrylate (PEGDMA), ethylene glycol diglycidyl ether, alkoxylated cyclohexanedimethanol diacrylate, dipentaerythritol pentaacrylate, ethoxylated trimethylolpropane triacrylate, ethoxylated trimethylolpropane triacylate, methoxy polyethylene glycol monomethacrylate, ethoxylated hydroxyethyl methacrylate, methoxy polyethylene glycol methacrylate, glycidyl methacrylate, polyamidoamine epichlorohydrin resin, trimethylolpropane triacrylate (TMPTA), piperazine diacrylamide, glutaraldehyde, or epichlorohydrin, as well as degradable crosslinking agents, including crosslinkers containing 1,2-diol structures (e.g., N,N′-diallyltartardiamide and ethylene glycol dimethacrylate), and functionalized peptides or proteins (e.g., albumin modified with vinyl groups).

Stimuli-responsive surface 20 may include more than one material (e.g., polymer, co-polymers) as well as an additive to modify or improve a particular property of the material (e.g., nanocomposites, nanostructures, nanoparticles, microparticles). Additional materials may include inorganic materials including, e.g., metals, ceramics and oxides. The polymer compositions may also include photoinitiators, such as, but not limited to, Irgacure 184, Irgacure 500, Irgacure 1173, Irgacure 2959, Darocur MBF, Irgacure 754, Irgacure 651, Irgacure 369, Irgacure 907, Irgacure 1300, Darocur TPO, Darocur 4295, Irgacure 819, Irgacure 2022, Irgacure 2100, Irgacure 784. The wavelength and intensity of the electromagnetic radiation used for photopolymerization will be dependent on the specific photoinitiator used. The wavelengths may range from microwave range to X-ray range. The stimuli-responsive surface 20 may further include additional layers including an adhesive on the non-transitioning side, surface modifications to the top surface 26, cells, and/or bio-active compositions, as described below.

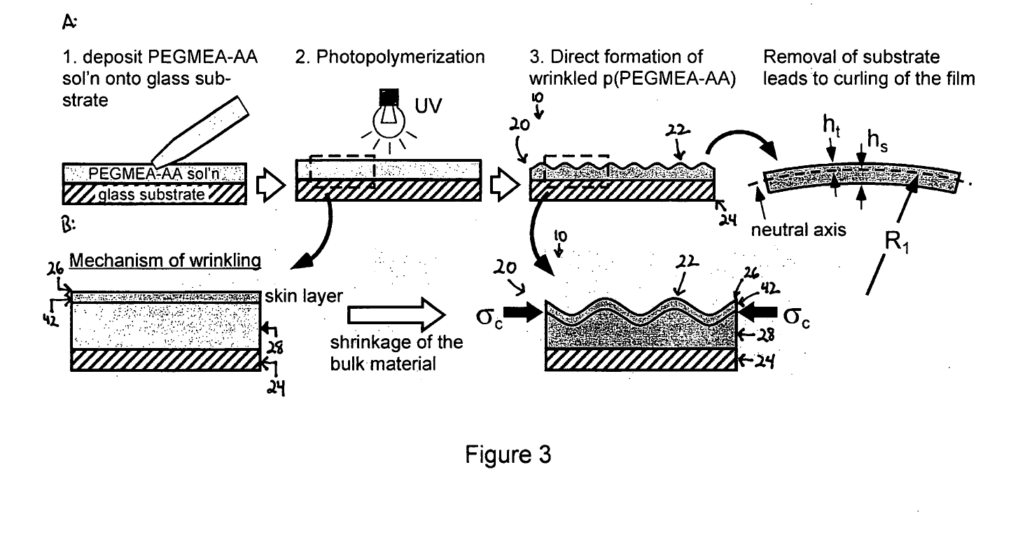

As shown, the stimuli-responsive surface 20 includes a substrate 24. The substrate 24 is of suitable rigidity and stiffness to prevent the wrinkled surface 20 from curling. See, e.g., FIG. 3. Exemplary substrate materials include, but are not limited to, metals, ceramics, polymeric materials, biocompatible materials, biodegradable materials.

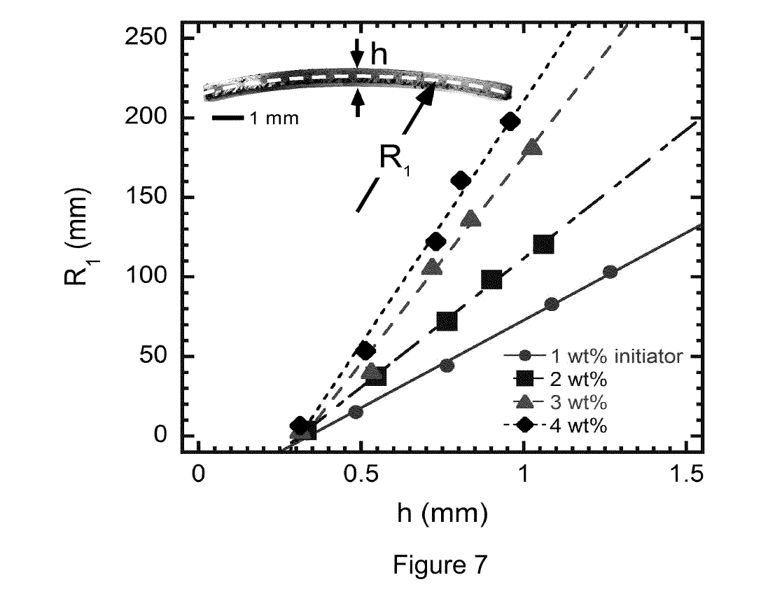

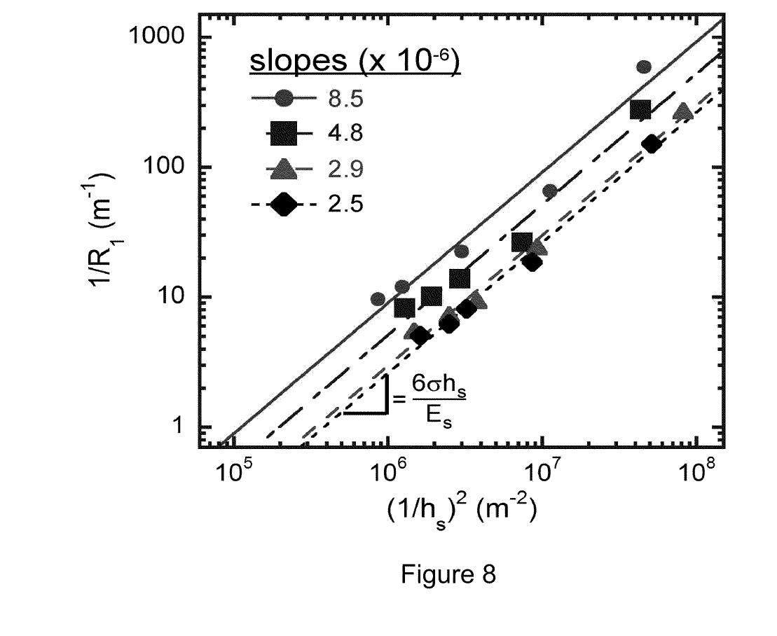

In one embodiment of the present invention the stimuli-responsive surface 20 is created through photopolymerization. The stimuli-responsive surface monomers are polymerized so that during initial polymerization a skin layer, or top layer 42 of the first polymerized monomer moieties is polymerized above the bulk layer 28. Eventually, substantially all of the material is polymerized. The top layer 42 retains slightly different physical properties as compared to the bulk layer 28, but in general because both layers are the same material they retain the same ultimate properties. Because of the physical properties mismatch internal tension is created in the top layer 42. If the stimuli-responsive surface 20 is confined or fixed to a substrate the stimuli-responsive surface 20 will develop surface texture features 22 (see, e.g., FIG. 3). FIGS. 7 and 8 illustrate a relationship between the degree of the surface texture feature 22 characteristics (e.g., wavelength and amplitude), tension in the stimuli-responsive surface 20 as manifested by the radius of curvature of an unbound stimuli-responsive surface 20. This relationship can be expressed in terms of stress based on the plate tectonic equation:

1/R₁=(6σhₛ/Eₛ)*(1/hₛ2)

In some embodiments, the top layer 42 has a thickness in the range of between about 100 nm and about 5 mm. In some embodiments, the thickness of the entire stimuli-responsive surface 20 is in the range of between about 200 nm to about 10 mm.

In some embodiments, a stimulus 30 (e.g. hydration) is applied. When hydration is applied as the exemplary stimulus of an exemplary stimuli-responsive surface 20 the water is absorbed through the top surface 26 of the stimuli-responsive surface 20. Because of the slight difference in properties of the top layer 42 and the bulk layer 28, osmotic stress, and the absorption the surface texture feature 22 are expanded, resulting in the transition from a first state to a second state, each characterized with different surface texture feature 22 characteristics (e.g. wavelength and amplitude), based on response to a stimulus 30 (e.g. hydration).

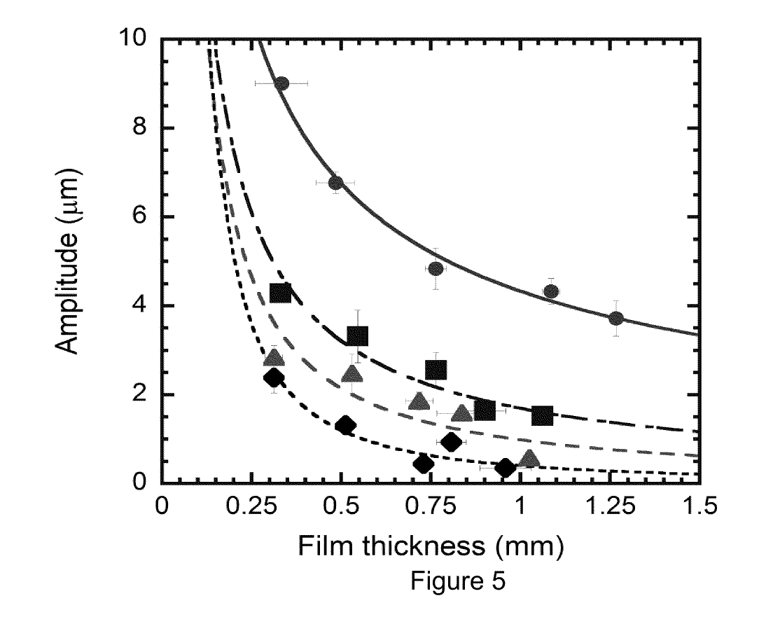

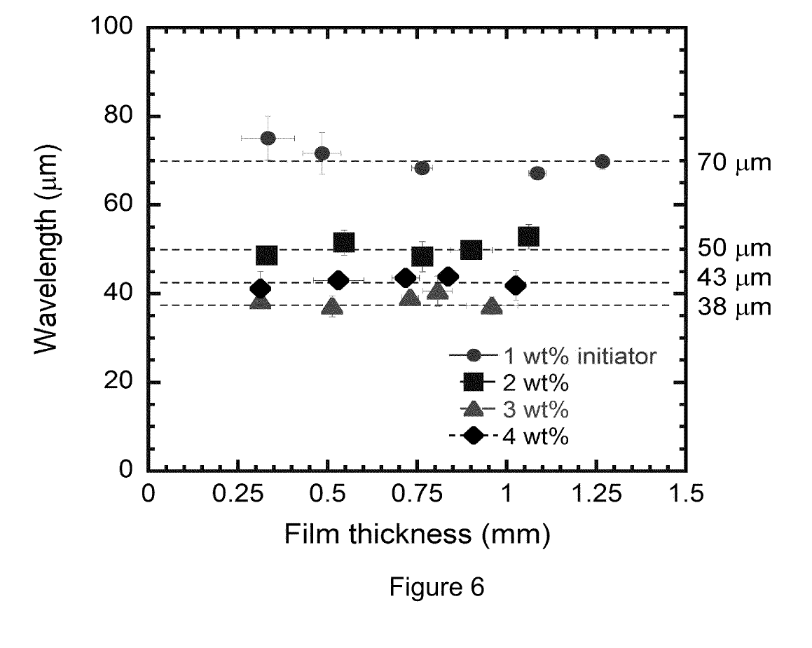

As shown in FIGS. 5 and 6, surface texture feature 22 characteristics (e.g., wavelength and amplitude) can vary based on the thickness of the top layer 42, the thickness of the entire stimuli-responsive surface 20 and/or the quantity of photoinitiator used in the initial pre-polymer mixture.

In the first state, the surface texture feature 22 can have an amplitude from approximately 0.25 micrometers to approximately 1000 micrometers. (The amplitude can be greater than or equal to approximately 0.25 μm, approximately 0.5 μm, approximately 1 μm, approximately 5 μm, approximately 10 μm, approximately 25 μm, approximately 50 μm, approximately 100 μm, approximately 150 μm, approximately 200 μm, approximately 250 μm, approximately 300 μm, approximately 350 μm, approximately 400 μm, or approximately 450 μm, approximately 500 μm, approximately 600 μm, approximately 700 μm, approximately 800 μm, approximately 900 μm, approximately 1000 μm; and/or less than or equal to approximately 1000 μm, approximately 900 μm, approximately 800 μm, approximately 700 μm, approximately 600 μm, approximately 500 μm, approximately 450 μm, approximately 400 μm, approximately 350 μm, approximately 300 μm, approximately 250 μm, approximately 200 μm, approximately 150 μm, approximately 100 μm, approximately 50 μm, approximately 25 μm, approximately 10 μm, approximately 5 μm, approximately 1 μm, approximately 0.5 μm, approximately 0.25 μm.). The surface texture feature 22 can have a wavelength (λ) from approximately 0.25 micrometers to approximately 1000 micrometers. (The wavelength can be greater than approximately 0.25 μm, approximately 0.5 μm, approximately 1 μm, approximately 5 μm, approximately 10 μm, approximately 25 μm, approximately 50 μm, approximately 100 μm, approximately 150 μm, approximately 200 μm, approximately 250 μm, approximately 300 μm, approximately 350 μm, approximately 400 μm, or approximately 450 μm, approximately 500 μm, approximately 600 μm, approximately 700 μm, approximately 800 μm, approximately 900 μm, approximately 1000 μm; and/or less than or equal to approximately 1000 μm, approximately 900 μm, approximately 800 μm, approximately 700 μm, approximately 600 μm, approximately 500 μm, approximately 450 μm, approximately 400 μm, approximately 350 μm, approximately 300 μm, approximately 250 μm, approximately 200 μm, approximately 150 μm, approximately 100 μm, approximately 50 μm, approximately 25 μm, approximately 10 μm, approximately 5 μm, approximately 1 μm, approximately 0.5 μm, approximately 0.25 μm.). In various embodiments, wavelength is measured by optical microscopy and amplitude is measured by optical profilometry. The ratio between the amplitude and wavelength of the surface texture feature 22 can be in the range from approximately 1:1 to approximately 100:1. The number of surface texture features 22 (e.g., wrinkles) can be in the range of approximately 10 features/cm² to approximately 1×10¹⁰ features/cm².

In the second state, the surface texture feature 22 can have an amplitude in the range from approximately 0.25 micrometers to approximately 1000 micrometers. (The amplitude can greater than or equal to approximately 0.25 μm, approximately 0.5 μm, approximately 1 μm, approximately 5 μm, approximately 10 μm, approximately 25 μm, approximately 50 μm, approximately 100 μm, approximately 150 μm, approximately 200 μm, approximately 250 μm, approximately 300 μm, approximately 350 μm, approximately 400 μm, or approximately 450 μm, approximately 500 μm, approximately 600 μm, approximately 700 μm, approximately 800 μm, approximately 900 μm, approximately 1000 μm; and/or less than or equal to approximately 1000 μm, approximately 900 μm, approximately 800 μm, approximately 700 μm, approximately 600 μm, approximately 500 μm, approximately 450 μm, approximately 400 μm, approximately 350 μm, approximately 300 μm, approximately 250 μm, approximately 200 μm, approximately 150 μm, approximately 100 μm, approximately 50 μm, approximately 25 μm, approximately 10 μm, approximately 5 μm, approximately 1 μm, approximately 0.5 μm, approximately 0.25 μm). The surface texture feature 22 can have a wavelength (λ) in the range from approximately 0.25 micrometers to approximately 1000 micrometers. (The wavelength can be greater than approximately 0.25 μm, approximately 0.5 μm, approximately 1 μm, approximately 5 μm, approximately 10 μm, approximately 25 μm, approximately 50 μm, approximately 100 μm, approximately 150 μm, approximately 200 μm, approximately 250 μm, approximately 300 μm, approximately 350 μm, approximately 400 μm, or approximately 450 μm, approximately 500 μm, approximately 600 μm, approximately 700 μm, approximately 800 μm, approximately 900 μm, approximately 1000 μm; and/or less than or equal to approximately 1000 μm, approximately 900 μm, approximately 800 μm, approximately 700 μm, approximately 600 μm, approximately 500 μm, approximately 450 μm, approximately 400 μm, approximately 350 μm, approximately 300 μm, approximately 250 μm, approximately 200 μm, approximately 150 μm, approximately 100 μm, approximately 50 μm, approximately 25 μm, approximately 10 μm, approximately 5 μm, approximately 1 μm, approximately 0.5 μm, approximately 0.25 μm.). The ratio between the amplitude and wavelength of the surface texture feature 22 can be in the range from approximately 1:1 to approximately 100:1. (e.g., approximately 1:1, approximately 2:1, approximately 5:1, approximately 10:1, approximately 20:1, approximately 25:1, approximately 30:1, approximately 40:1, approximately 50:1, approximately 60:1, approximately 75:1, approximately 80:1, approximately 90:1, approximately 100:1) The number of surface texture features 22 (e.g., wrinkles) can be in the range of approximately 10 features/cm² to approximately 1×10¹⁰ features/cm². The ratio between the physical features of the surface texture features 22 between the first state and the second state may be in the range between approximately 2:1 to approximately 1:100. (The ratio may be greater than approximately 2:1, approximately 1:1, approximately 1:2, approximately 1:5, approximately 1:10, approximately 1:20, approximately 1:25, approximately 1:30, approximately 1:40, approximately 1:50, approximately 1:60, approximately 1:75, approximately 1:80, approximately 1:90, approximately 1:100; and/or less than approximately 1:100, approximately 1:90, approximately 1:80, approximately 1:75, approximately 1:60, approximately 1:50, approximately 1:40, approximately 1:30, approximately 1:25, approximately 1:20, approximately 1:10, approximately 1:5, approximately 1:2, approximately 1:1, approximately 2:1)

In various embodiments, bio-active compounds and/or cells can be added to the stimuli-responsive surface 20 using covalent and/or non-covalent interactions. Exemplary non-covalent interactions include hydrogen bonds, electrostatic interactions, hydrophobic interactions, and/or van der Waals interactions. The biomolecules can be used, for example, to recruit cells to a wound site and/or to promote a selected metabolic and/or proliferative behavior in cells that are at the site and/or seeded in substrate 22 and/or an adherent layer on stimuli-responsive surface 20 (described below). Examples of biomolecules include growth factors or ligands such as, without limitation, transforming growth factor beta (TGF-β), acidic fibroblast growth factor, basic fibroblast growth factor, epidermal growth factor, insulin growth factor I and II (IGF-I and II), vascular endothelial-derived growth factor, bone morphogenetic proteins, platelet-derived growth factor, heparin-binding growth factor, hematopoetic growth factor, and peptide growth factor. Furthermore, the compounds listed under the definition of bioactive agents in the definitions section may also be added the stimuli responsive surface. In certain embodiments, integrins and cell adhesion sequences (e.g., the RGD sequence) are attached to substrate 24, the stimuli-responsive surface 20, and/or the surface texture feature 22 to facilitate cell adhesion. Extracellular matrix components, e.g., collagen, fibronectin, laminin, elastin, etc., can also be combined with substrate 24 and/or an adherent layer on stimuli-responsive surface 20 to manipulate cell recruitment, migration, and metabolism, and the degradation and mechanical properties of the material. In some embodiments, proteoglycans and glycosaminoglycans are covalently or non-covalently attached to substrate 24 and/or an adherent layer of stimuli-responsive surface 20. Additional biomolecules may include RNAi and vitamins.

As indicated above, substrate 24, stimuli-responsive surface 20, and/or surface texture feature 22 can be seeded with a variety of cells. For example, the cells can be delivered by adhesive article 20 for tissue regeneration. The cells can also facilitate remodeling of adhesive article 20 into new tissue. In some embodiments, the cells can deliver (e.g., secrete) a drug or a factor that has a therapeutic effect. Examples of cells include kerotinocytes, fibroblasts, ligament cells, endothelial cells, epithelial cells, muscle cells, nerve cells, kidney cells, lung cells, hepatocytes, neuroblastoma, skin cells, islet cells, urothelial cells, bladder cells, intestinal cells, chondrocytes, bone-forming cells, and/or stem cells, such as human embryonic or adult stem cells or mesenchymal stem cells, reprogrammed cells, hematapoetic cells, cardiac cells, cells from Wharton's jelly and perivascular cells.

Alternatively or additionally, stimuli-responsive surface 20 can include surface protrusions, as described in International Patent Application serial numbers PCT U.S. Ser. No. 08/083,980, entitled “Adhesive Articles,” the entire contents of which are hereby incorporated by reference.

Alternatively or additionally, stimuli-responsive surface 20 can include surface modifications to further manipulate or control adhesiveness. Surface modification is provided to enhance the adhesiveness of stimuli-responsive surface 20 e.g., relative to an stimuli-responsive surface without the surface modification. Surface modification can also maintain a barrier for tissue-tissue adhesion or for tissue-device adhesion. Surface modification can be on substrate 24 only, on selected surface texture features 22 (e.g., on all the surface texture features), on stimuli-responsive surface 20, or on any combination of the parts. In some embodiments, surface modification provides one or more of: (a) a functionalization of the surface of substrate 24 or stimuli-responsive surface 20 (e.g., by chemical reaction to provide aldehyde functional groups); and/or (b) addition of an adherent layer including a moiety capable of bonding to a biological tissue. For example, surface modification can render the surface of substrate 24, stimuli-responsive surface 20 and/or surface texture features 22 capable of covalently bonding to the biological tissue, e.g., via covalent bonding of aldehyde functional groups to amine groups on the biological tissue surface. As other examples, surface modification can include one or more of the following functional groups: a carbonyl, an aldehyde, an acrylate, a cyanoacrylate, and/or an oxirane. In some embodiments, surface modification includes an layer of adherent present in an amount less than approximately 20 nanomoles per square centimeter of projected area (e.g., from approximately 1 nanomole to approximately 20 nanomoles per square centimeter of projected area).

Alternatively or additionally to surface modification, in some embodiments, one or more sacrificial layers are used to provide stimuli-responsive surface 20 that can be adjusted or re-positioned before the stimuli-responsive surface completely adheres to its intended surface (e.g., tissue). The sacrificial layers are removed from the surface of substrate 24, stimuli-responsive surface 20 and/or surface texture features 22 before adhesive device 10 is completely adhered to the application site. Chemical and/or physical interactions with tissue can be one mechanism through which a sacrificial layer is removed from the surface of adhesive device 10. For example, the sacrificial layer can include a salt coating or barrier that slowly dissolves when applied to tissue. The slow dissolution provides the user time to re-adjust or re-position adhesive device 10 before the article adheres too strongly to the tissue. Other methods through which the sacrificial layer can be removed include, but are not limited to, light, pH, temperature, sound and/or physical mechanisms. As another example, adhesive device 10 can include pressure-sensitive particles that contain a release agent (e.g., biomolecules). After adhesive device 10 is correctly positioned (e.g., on tissue), sufficient pressure (or another mechanism to activate adhesion such as temperature change) can be applied to release the release agent and/or achieve adhesion. Alternatively or additionally to being on adhesive device 10, the sacrificial layer can be applied to the application site (e.g., tissue) prior to contacting the adhesive article to the site.

In other embodiments, the sacrificial layer is engineered to stay at an applied adhesion site and to degrade over a selected time period after adhesive composition 10 is removed from the adhesion site. For example, patterns resulting from contact of adhesive composition 10 containing the sacrificial layer can remain on the contacting tissue surface after article 20 is removed. These patterns can, for example, provide sites for cell attachment or localized points of adhesion and/or visible marks for surgical applications.

In some embodiments, adhesive device 10 can be removed by a release agent including a mildly basic or acidic solution with a pH higher or lower than 7 or by light. Alternatively or additionally, adhesive device 10 can be removed by a release agent including an esterase enzyme, such as cholesterol esterase. Such release agents can be useful when adhesive composition 10 is removed from the tissue, and a new adhesive can be applied, and/or to remove the adhesive composition 10 after its intended use is fulfilled.

In some embodiments, at least a portion of adhesive device 10 capable of covalently bonding to a biological tissue has an interfacial surface area that is approximately 1.2 times greater than the projected surface area of the portion. Covalent bonding of adhesive device 10 to a biological tissue can be reversed by application of a biodegradable and biocompatible release agent (e.g., a drug, protein, peptide, suspended particle, DNA, and RNA). For example, the release agent can be active when the tissue has developed the correct geometry or connectivity at the interface with adhesive composition 10, at which time the release agent is activated.

In various embodiments, the stimulus can include, but is not limited to, hydration of the stimuli-responsive surface 20, dehydration of the stimuli-responsive surface 20, change in solvent, change in pH, change in temperature, change in pressure, exposure to electromagnetic radiation, enzymatic activity, change in ionic strength, application of an electric field, application of a magnetic field, application of mechanical stress and combinations thereof. In various embodiments, the enzymes applied for enzymatic activity stimulus, include by are not limited to hydrolases, oxidoreductases, transferases, lyases, isomerases and ligases.

### Application

In various aspects, the stimuli-responsive surface 20 is applied to a superstrate (e.g., a biological tissue). In various embodiments, the stimuli-responsive surface 20 undergoes the transitions from the first state to the second state after or while in contact with the superstrate. In doing so, the stimuli-responsive surface 20 increases the adhesive strength of the bond between the stimuli-responsive surface 20 and the superstrate. Because of the transition between the first state and the second state, the surface area and the contact line between the stimuli-responsive surface 20 and the superstrate are increased, increasing the adhesive strength of the bond.

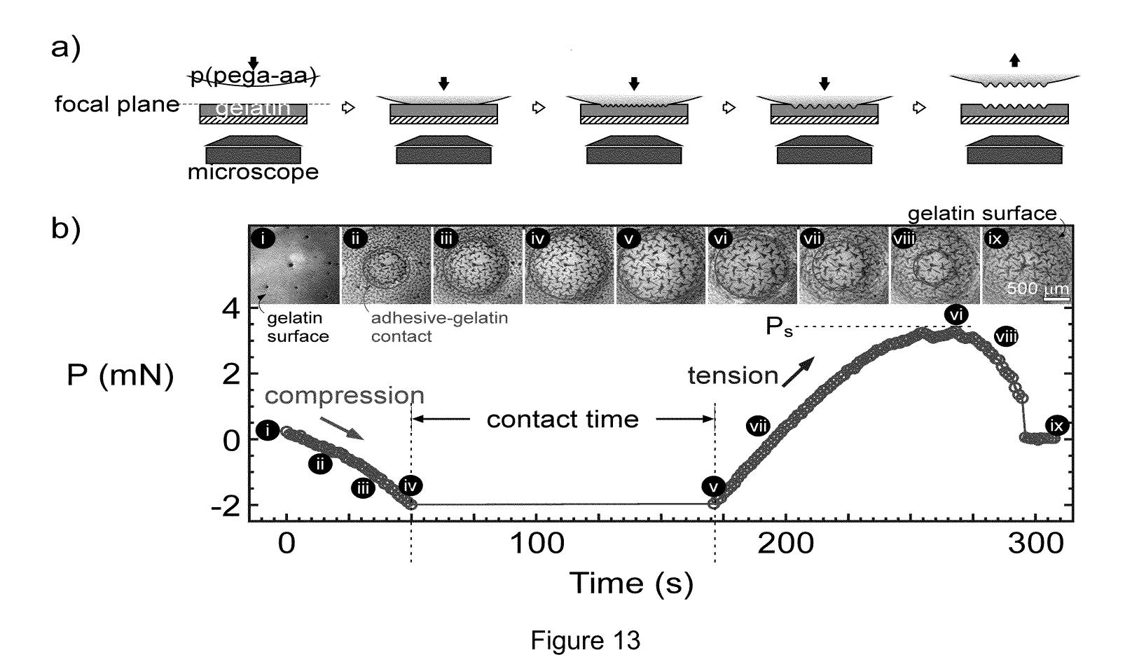

Referring to FIG. 13, the application of the stimuli-responsive surface 20 to a superstrate (e.g., gelatin) is illustrated. The stimuli-responsive surface 20 is introduced to the superstrate while the stimuli-responsive surface 20 is in the first state. After contact with the superstrate, the stimulus 30 is applied (e.g., hydration of the stimuli-responsive surface 20 by water in the gelatin). The stimulus causes the transition to the second state during the contact time. When the stimuli-responsive surface 20 is pulled away from the superstrate at a constant rate of speed, the force required will change as the surface area and contact line change while the interface of the stimuli-responsive surface 20 and superstrate change. (see, e.g., FIG. 13B chart). When transitioning from a relatively smooth first state to a more irregular second state with increased texture amplitude, the stimuli-responsive surface 20 and the compliant surface both change topology. The change in surface texture feature 22 (e.g., change in amplitude, wavelength) results in pinning of the superstrate material, improving adhesion. Coincident with the pinning phenomena is an increase in the contact line between the stimuli-responsive surface 20 and the superstrate. Because of the rumpled topology of the surfaces, the border of the interface between the stimuli-responsive surface 20 and the superstrate is greater. This greater contact line is illustrative of greater adhesive strength when compared to identical material and circumstances save for the topology of the surfaces. In a similar, but inverse manner, de-adhesion or separation may be manipulated or controlled. Separation of the stimuli-responsive surface 20 and the superstrate can be accomplished without inducing a surface transition or stimulus change. When removal of the stimuli-responsive surface 20 from the superstrate is desired, this may be accomplished in several ways, e.g., the stimuli-responsive surface 20 may simply be removed by force. In various embodiments, the stimulus may be removed, or the stimulus applied to induce a transition in order to aide or ease separation.

In various embodiments, the superstrate is a deformable, or compliant material. When the superstrate is deformable, the stimuli-responsive surface 20 can reshape the interface as the stimuli-responsive surface 20 undergoes the transition from a first state to a second state or vice versa, provided the stimulus 30 is applied after contacting the stimuli-responsive surface 20 and the superstrate. The superstrate may be wet or dry material. In various embodiments, the adhesive strength of the bond will change with contact time, either reaching a maximum or a minimum as the stimuli-responsive surface 20 transitions from one state to the other occurs.

In various embodiments, the degree of stimulus and therefore the ultimate adhesive strength can be controlled or manipulated. For example the available water content of the superstrate may be limited so that the stimuli-responsive surface 20 does not fully reach the maximum amplitude or wavelength capable in the second state. Or, for example, the stimulus may be removed to reduce adhesion and improve or ease separation of the stimuli-responsive surface 20 and the superstrate.

Although the above descriptions are in the context of improved adhesion or adhesive strength, stimuli-responsive surface 20 can also be used to promote and control de-adhesion or separation, by control or manipulation of the surface texture feature 22 transition.

### Application of Stimuli-Responsive Surface to Substrates

In various embodiments, the stimuli-responsive surface 20 may be applied to any substrate in any suitable manner (e.g., spray coating, spin coating). In various embodiments, the polymeric material may be applied as the coating to the substrate. In various embodiments, a monomer mixture may be applied to the substrate. In some embodiments, the coating is accomplished with a solvent. The solvent may be evaporated prior to polymerization, when a monomer solution is applied. The solvent may be evaporated prior to use, if a polymer is applied. In various embodiments, an adhesive may be applied between the stimuli-responsive surface 20 and the substrate upon which it is coated. In some embodiments, the adhesive material is incorporated into the bulk of the stimuli-responsive surface 20, either in the monomer mixture or in layers if a polymer applied.

### Methods of Making

Materials synthesis P(PEGA-AA) films and hemispheres are synthesized using a photocurable acrylate formulation comprising a mixture of acrylate monomers and crosslinker (e.g., polyethylene glycol methyl ether acrylate, acrylic acid and polyethylene glycol dimethacrylate) and a photoinitiator. The monomers, crosslinker and photoinitiator are combined to form a clear, homogeneous solution. A controlled volume of this solution is deposited into a mold and irradiated with electromagnetic radiation at a specific wavelength and specific intensity. (e.g., λ=365 nm, intensity=20 MW/cm2) for a set period of time or polymerize a portion or the entire mixture. (e.g., photopolymerization time may be approximately 30 seconds, approximately 1 minute, approximately 2 minutes, approximately 4 minutes, approximately 5 minutes, approximately 10 minutes; or photopolymerization may be sufficiently long to polymer approximately 1% of the mixture, approximately 10% of the mixture, approximately 25% of the mixture, approximately 50% of the mixture, approximately 75% of the mixture, approximately 100% of the mixture). The wavelength and intensity of the electromagnetic radiation used for photopolymerization will be dependent on the specific photoinitiator used. The wavelengths may range from microwave range to X-ray range. Portions of the solution are deposited onto glass substrates to form the films. Alternatively or additionally portions of the solution solutions are deposited onto hemispherical silicone molds to form the hemispheres.

### EXAMPLES

### Experimental

Materials synthesis P(PEGA-AA) films and hemispheres are synthesized using a photocurable acrylate formulation consisting of polyethylene glycol methyl ether acrylate (74 wt %) (PEGA), acrylic acid (AA) (24 wt %) and polyethylene glycol dimethacrylate (2 wt %) (Sigma-Aldrich, St. Louis, Mo.), and commercial photoinitiator Irgacure™ 819 (Ciba Specialty Chemicals, Tarrytown, N.Y.). The monomers, crosslinker and photoinitiator are combined to form a clear, homogeneous solution. A controlled volume of this solution is deposited into a mold and irradiated with ultraviolet light (λ=365 nm, intensity=20 MW/cm2) for 4 minutes. 1 mL solutions are deposited onto 2.54 cm2 glass substrates to form the films and 0.5 mL solutions are deposited onto hemispherical silicone molds to form the hemispheres.

Gelatin solutions are created by mixing Bloom 225 (12.5 wt %) with hot deionized water (81.5 wt %) to form a homogeneous solution. The gelatin films are fabricated by depositing 1 mL solutions onto 2.54 cm2 glass substrates. The films are used immediately to minimize water content change.

Pdms probes are made by mixing thoroughly Dow Corning Sylgard 184 oligmer with catalyst (10 to 1 by wt) and then degassing for 45 min. The degassed mixture is cast onto plastic hemispherical molds and cured at 70° C. for 2 hr. to yield the elastomeric hemispheres.

Contact adhesion testing: Adhesion of all the materials is characterized using a custom-built contact adhesion test. The test is carried out at fixed displacement rate (˜1.5 μm/s) conditions and begins by bringing a hemispherical probe (either p(PEGA-AA) or PDMS), into contact with the gelatin surface; upon forming a defined interfacial contact, the probe is then subsequently separated to break the interface. During the entire test, the force (P), displacement (δ) and contact area (A=πap2) developments are recorded via a custom-developed application using National Instruments LabVIEW® software. The force is monitored by a force transducer (1 kg load cell, Honeywell Sensotec, Columbus, Ohio) connected in series with a nanoposition manipulator (Burleigh Instruments Inchworm Model IW-820) that controls the displacement. The interfacial contact areas are captured using a CCD camera (Nikon) mounted in-line with the inverted optical microscope (bright field, objective=2.5×, Nikon). For each contact time, we have performed at least 3 contact adhesion tests to verify the consistency in the material's adhesive properties.

Theoretical estimation of true contact area The true contact area for a wrinkled interface is estimated by calculating the number of wrinkles (n) that occupy the contact area at Pₛ(Aₛ). We assume that the wrinkles are arranged in a close-packed arrangement.

n=0.85*(λ²/Aₛ) (M.1)

The surface area for a single wrinkle (Aw) is estimated as a hemisphere, hence, Aw is:

A_{w}=4π*(λ/2)² (M.2)

Therefore, As is determined by the product of eqn. M.1 and M.2.

Aₛ=0.85π*(λ4/Aₛ) (M.3)

The relative true contact area is defined as the ratio of As at contact time=t versus As at contact time=0.

Relative True Contact Area=A_{s,t}/A_{s,t=0} (M.4)

### Discussion

We demonstrate the application of these responsive surface wrinkles in controlling the adhesion of a wet, compliant interface (FIG. 13). Using an axisymmetric probe-type contact adhesion test, we measure the adhesion of the p(PEGA-AA) elastomer in contact with a wet, deformable gelatin surface. The test measures adhesion by measuring the force (P), displacement (δ) and interfacial contact area (πa2) required for interfacial formation between the elastomer and gelatin surfaces (FIG. 13a). Optical micrographs of the interfacial contact history of a representative test are presented in FIG. 13b. The test begins by approaching the p(PEGA-AA) hemispherical probe into contact with the gelatin substrate until a critical compressive load is reached. As the probe is continually compressed into the gelatin, the contact area grows laterally and reaches the maximum contact at the critical force. Upon reaching this critical point, the interface is allowed to remain in contact for a predetermined time. After this contact time, the probe retracts from the gelatin surface and the test completes when the entire interface separates. The force-time history curves of the adhesion test is presented in FIG. 13b. A maximum tensile force (Ps) develops prior to complete separation, and we use this quantity as a descriptor of adhesion. We allow the adhesive to interact with the gelatin for a predefined contact time to understand the effects of contact time on adhesion. While we observe that the contact area grows during this contact time (FIG. 13b, micrograph iv to v), the force-time curve shows that the compressive force does not change significantly. This indicates that the swelling process does increase the overall dimensions of the adhesive probe significantly. Instead, the swelling simply causes a local change in the probe geometry in the form of surface wrinkling, which is represented schematically in FIG. 13a.

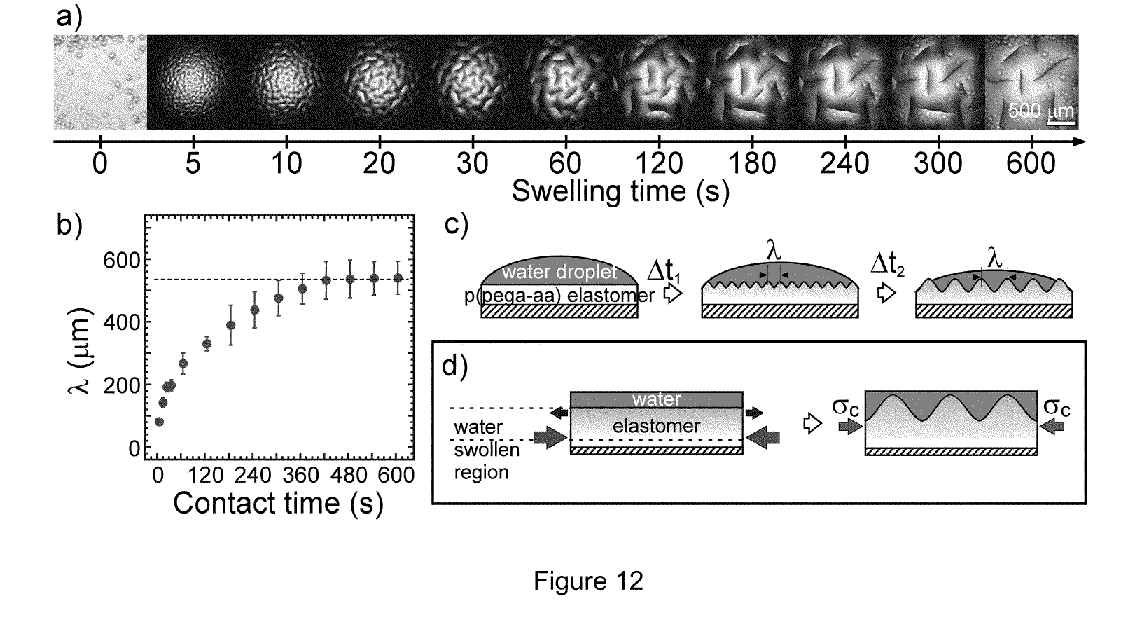

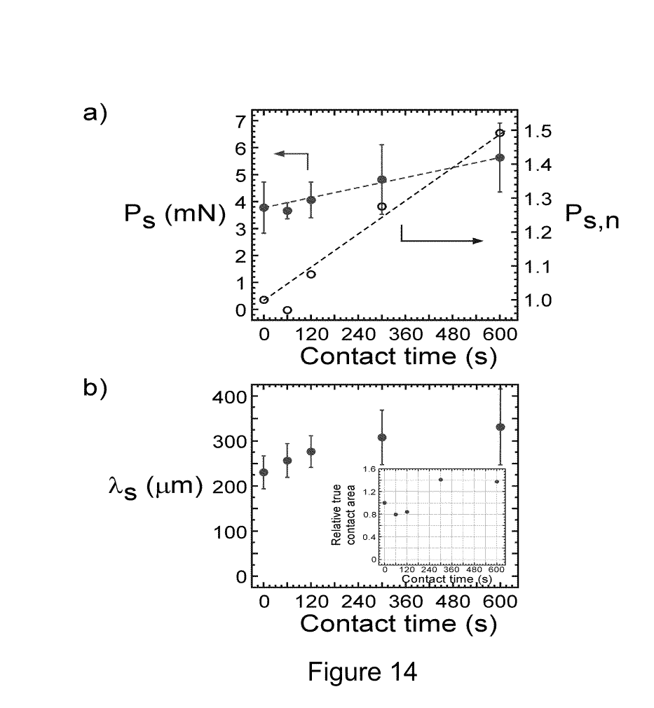

During the test, the interface develops surface wrinkles with a similar morphology observed in FIG. 12. This suggests that the elastomer is wrinkling by absorbing the water present at the gelatin surface. Additionally, the wrinkle morphology evolves over the duration of the test, which is again consistent with the results in FIG. 12. To understand the role of the surface wrinkles in contributing to the adhesion of the material, we performed a series of adhesion tests as a function of contact time ranging from 0 to 600 sec. We selected 600 sec. of contact time as the longest interaction time based on the required time for the surface wrinkles to stabilize as observed in FIG. 12b. A summary of Ps values as a function of contact time is presented in FIG. 14a. The results show that adhesion, as described by Ps, increases with contact time. As a comparison, we normalize Ps at time=t to time=0 s and develop a normalized descriptor (Ps,n). In general, Ps,n increases with contact time and in comparing between the shortest (t=0 sec.) to the longest (600 sec.) contact time, we find that the adhesion is enhanced by ˜50% simply by increasing the contact time of the interface (FIG. 14a).

The wrinkling of the p(PEGA-AA)-gelatin interface is mechanistically similar to wrinkling of p(PEGA-AA) in water (FIG. 12); wrinkles develop at the elastomer-gelatin interface due to the competition of osmotic pressure and lateral confinement.

The second and more important aspect is related to the utilization of responsive wrinkles for device application. Specifically, we are taking advantage of responsive wrinkles to improve interfacial contact and stability with another polymer surface. From the final optical micrograph of the gelatin surface, following detachment of the wrinkled adhesive, the gelatin surface has also developed surface wrinkles (FIG. 13b). This suggests that the deformable gelatin is in conformal contact with the wrinkled adhesive over the entire contact time, which is accomplished by developing a complimentary wrinkled surface. As a result, interfacial contact is significantly enhanced at the p(PEGA-AA)-gelatin interface due to this complimentary wrinkling. The gelatin surface preserves this morphology due to water absorption by the p(PEGA-AA) adhesive that dries the gelatin. Since the gelatin film is finite in thickness, there is insufficient water present to replenish this wrinkled surface to recover back to the original smooth surface.

The enhancement of adhesion with contact time is one of mechanisms of adhesion for dry pressure-sensitive adhesives; adhesion is improved over time since the viscous adhesive flows and improves true interfacial contact with a rough surface. For our materials, improved interfacial contact is attributed to the development of an elastic instability. This adhesion enhancement with contact time for a wet interface is a novel property that has not been previously observed. The wrinkles grow in wavelength as the contact time increases (FIG. 14b), which subsequently leads to a proportional increase in its amplitude. Intuitively, one would expect that the increase in wavelength and amplitude increases the true contact area, and results in enhanced adhesion. However, theoretical estimation of the true contact area at the point of Ps suggests that true area does not contribute to enhanced adhesion since the changes in the true contact area with contact time is uncorrelated (inset, FIG. 14b). To determine the exact contribution of the surface wrinkles, we must understand the specific separation process that occurs at the point of maximum separation.

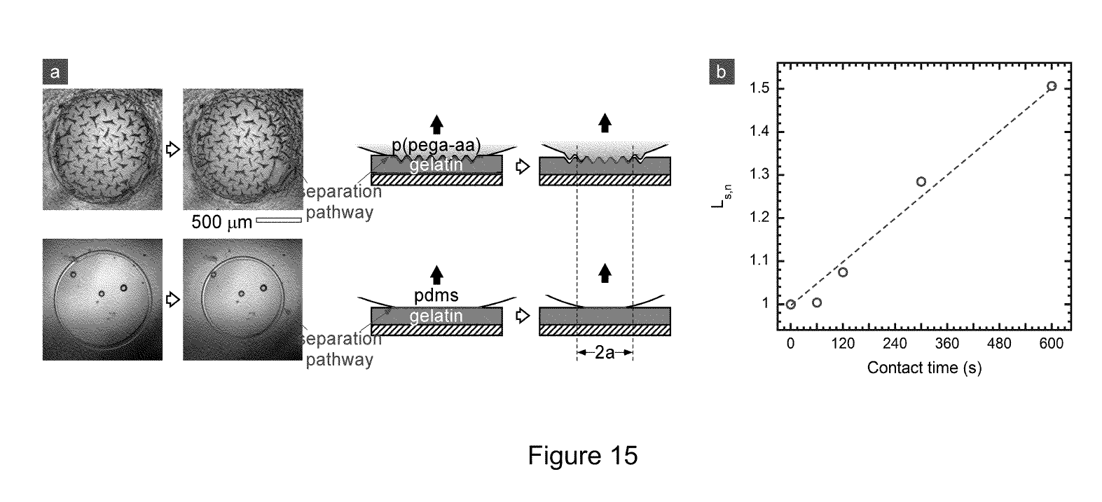

To understand the separation process of a wrinkled surface, we first consider the simpler separation process observed in typical soft adhesives. As a reference system, we choose crosslinked polydimethyl siloxane (PDMS) as the non-wrinkled adhesive and visualize the separation process as it interacts with the gelatin surface. Due to the hemispherical shape of the PDMS probe, the interfacial separation initiates at the periphery of the PDMS probe-gelatin interface. As shown in FIG. 15a, the separation of the PDMS hemisphere from the gelatin surface proceeds through a smooth, continuous peeling from the perimeter of the interface.

The surface wrinkles define a complex topological interface that enhances the critical contact line at separation (FIG. 15a). Unlike the separation process of the PDMS-gelatin system characterized by a continuous 2-dimensional peeling at the interface, the separation for the wrinkled adhesive-gelatin system occurs through a more tortuous 3-dimensional peel process. We can imagine the peel process occurring in an intermittent manner due to the “self-interlocking” effect. Similar to the PDMS-gelatin system, the peel process initiates at the perimeter of the p(PEGA-AA) hemispherical probe-gelatin interface. As the peel front traverses along the wrinkled interface, the peaks and valleys of the wrinkles disrupt the peel process by locally pinning, or delaying, the contact line from separating. This “self-interlocking” process causes local disruption of the contact line and strengthens the interface by preventing the peel front from separating too quickly. As a result, this leads to a lengthening of Ls and overall enhancement in Ps.

To understand the effect of contact time with changes in the contact line, we relate the normalized contact line at separation (Ls,n) to contact time (FIG. 15b). The normalized contact line is defined as the ratio of the Ls at contact time=t to Ls at contact time=0 s (Ls,n=Ls,t/Ls,t=0). We find that the contact line increases with contact time, which would appear to suggest that wavelength is the primary length-scale of control since the wavelength also grows with contact time (FIG. 14b). However, previous work has demonstrated that enhancement of Ls is inversely proportional to wrinkle wavelength, which contrasts with our results. Rather, we believe that the wrinkle amplitude is the primary pattern length-scale in determining the degree of interlocking since the amplitude scales directly with the wavelength. In other words, an increase in the wrinkle amplitude provides greater resistance for crack propagation since the crack front must traverse a longer pathway along the wrinkle surface in order to cause separation. Hence, the increase in wrinkle amplitude leads to greater pinning of the contact line, and further enhancement in adhesion. Naturally, this enhancement eventually reaches a plateau since the wrinkle amplitude cannot grow infinitely due to material (the expansion due to swelling is finite) and geometric (the adhesive is in confined by the gelatin) constraints. We observe this limit experimentally since enhancement appears to reach the maximum value at a contact time of 10 min., and remains at the same Ps value at a contact time of 1 hr.

What is claimed is:

1. A material capable of promoting adhesion through transitioning reversibly between a first state and a second state when the material is exposed to or removed from a stimulus,
wherein, the first state comprises a first texture and the second state comprises a second texture different from the first texture.

2. The material of claim 1 wherein, when the stimulus changes the texture returns to the first state.

3. The material of claim 1 wherein the change in stimulus is selected from the group consisting of removal of the stimulus, reduction in the degree of the stimulus, increase in the degree of the stimulus, addition of a second stimulus.

4. The material of claim 1 wherein the material is a polymer.

5. The material of claim 1 wherein, the material locally pins the interface contact from receding.

6. The material of claim 1 wherein, de-adhesion can be promoted by removing the stimulus.

7. The material of claim 1, wherein during the first state the texture has amplitude in the range of between about 250 nm and about 500 nm and wavelength in the range of between about 250 nm and about 500 nm and during the second state the texture has amplitude in the range of between about 250 μm and about 500 μm and wavelength in the range between of about 250 μm and about 500 μm.

8. The material of claim 1 wherein the texture has during the first state the texture has amplitude in the range of between about 1 μm and about 50 μm and wavelength in the range of between about 25 μm and about 75 μm and during the second state the texture has amplitude in the range of between about 200 μm and about 300 μm and wavelength in the range between of about 250 μm and about 500 μm.

9. The material of claim 1 further comprising a substrate or mold.

10. The material of claim 9 further comprising an adhesive between the material and substrate.

11. The material of claim 1 wherein the stimulus is selected from the group consisting of hydration/dehydration, change in solvent, change in pH, change in temperature, change in pressure, exposure to electromagnetic radiation, enzymatic activity, change in ionic strength, application of an electric field, application of a magnetic field, application of mechanical stress and combinations thereof.

12. The material of claim 11 wherein the stimulus is hydration.

13. The material of claim 12 wherein the hydration is from a tissue.

14. The material of claim 4 where in the polymer is selected from the group consisting of poly(ethylene glycol methyl ether acrylate-co-acrylic acid) (“p(PEGA-AA)”), poly(glycerol sebacate)(PGS), poly(glycerol sebacate acrylate) (PGSA), poly(lactic-co-glycolic acid) (PLGA), polycaprolactone (PCL), polyglycolide (PGA), polylactic acid (PLA), poly-3-hydroxybutyrate (PHB), polyurethane, parylene-C, keratin, carbon nanotubes, poly(anhydride), chitosan, 2-hydroxyethylmethacrylate, hylauronic acid, poly(acrylic acid), poly(ethylene glycol), copolymers and combinations thereof.

15. The material of claim 4 wherein the polymer is a bilayer of bulk material layer and a top layer.

16. (canceled)

17. The material of claim 15 wherein the top layer is formed from the monomers of the bulk material during initial polymerization.

18. The material of claim 4 wherein the polymer is cross-linked.

19. The material of claim 1 further comprising a biomolecule or pharmaceutical compound.

20. (canceled)

21. The material of claim 1 further comprising a plurality of cells.

22. (canceled)

23. The material of claim 1 wherein the texture has a pattern.

24. The material of claim 1 wherein the texture is in a random arrangement.

25. The material of claim 1 wherein the transition from the first state to the second state results in a change in the range between about 50%, and about 500%.

26. The material of claim 1 in the form of a tape.

27. The material of claim 1 wherein the adhesion against deformable surfaces is greater than adhesion against rigid surfaces.

28. The material of claim 1 wherein the material is contacted to a superstrate.

29. The material of claim 28 wherein the material is adhered to a wet, deformable superstrate.

30. The material of claim 28 where in the material is adhered to a dry, deformable superstrate.

31. The material of claim 28 wherein the material increase the contact line at separation of the material and superstrate due to the transition from one state to the other.

32. The material of claim 31 wherein the contact line is increased by locally pinning the separation pathway due to the transition from one state to the other.

33. The material of claim 28 wherein the material and superstrate can be de-adhered through transitioning from one state to the other.

34. The material of claim 33 wherein the transition decreases the contact line at separation.

35. The material of claim 28 wherein the superstrate prevents complete reversal of the transition from the first state to the second state.

36. The material of claim 1, wherein the adhesive strength is increased as the amplitude of the texture increases.

37. The material of claim 36 wherein the increase in adhesive strength is coincident with increase in contact time with a superstrate.

38.-39. (canceled)

40. The material of claim 1 further comprising additives.

41. (canceled)

42. A method comprising
contacting a material with a superstrate, the material comprising
a material capable of promoting adhesion through transitioning reversibly between a first state and a second state when the material is exposed to or removed from a stimulus,
wherein, the first state comprises a first texture and the second state comprises a second texture different from the first texture

43.-69. (canceled)

70. A method of making a composition comprising:
photo polymerizing a mixture of polymers and a photoinitiator in a mold or a rigid substrate.

71.-72. (canceled)

73. A method of improving adhesion comprising
contacting a stimuli response material with a superstrate
applying a stimulus
wherein the stimulus causes the stimuli responsive material to transition from a first state to a second state
wherein the second state has a more irregular topology relative to the first state.
